(19) United States
(12) Patent Application Publication
(10) Pub. No.: US 2010/0174521 A1
(43) Pub. Date: Jul. 8, 2010

(54) DATA PROCESSING WITH CIRCUIT MODELING

(75) Inventors: Timothy Allen Pontius, Crystal Lake, IL (US); Gregory E. Ehmann, Sleepy Hollow, IL (US); Robert L. Payne, San Jose, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/720,824

(22) PCT Filed: Dec. 2, 2005
(86) PCT No.: PCT/IB2005/054031

§ 371 Date: Mar. 25, 2010

Related U.S. Application Data
(60) Provisional application No. 60/633,286, filed on Dec. 3, 2004.

(51) Int. Cl. G06G 7/62

(52) U.S. Cl. 703/15

(57) ABSTRACT

Various aspects of the present invention are directed to design modeling and/or processing of streaming data. According to an example embodiment, a system to model a hardware specification includes a platform (106) arranged to receive an input data stream and transmit an output data stream. The system also includes a source (102) for a streaming application adapted to provide the input data stream at a source data rate, a destination (104) for the streaming application adapted to consume the output data stream at a destination data rate, and a data channel (110) coupling the platform and a computer (108). The computer uses the hardware specification to generate intermediate data streams, which, in turn, are used to streamline the modeling for the platform.

The present invention is directed generally to modeling for streaming applications. More particularly, the present invention relates to methods and arrangements for real-time, or near real-time, modeling for streaming applications.

The electronics industry continues to strive for high-powered, high functioning circuits. Significant achievements in this regard have been realized through the fabrication of very large-scale integration of circuits on small areas of silicon wafer. Integrated circuits of this type are developed through a series of steps carried out in a particular order. The main objective in designing such devices is to obtain a device that conforms to geographical features of a particular design for the device. To obtain this objective, steps in the designing process are closely controlled to insure that rigid requirements are realized.

Semiconductor devices are used in large numbers to construct most modern electronic devices. In order to increase the capability of such electronic devices, it is necessary to integrate even larger numbers of such devices into a single silicon wafer. As the semiconductor devices are scaled down (i.e., made smaller) to form a larger number of devices on a given surface area, the structure of the devices and the fabrication techniques used to make such devices become more refined. This increased ability to refine such semiconductor devices has lead to an ever-increasing proliferation of customized chips, with each chip serving a unique function and application. This, in turn, has lead to various techniques to design and successfully test chips efficiently and inexpensively.

For many chip designs, customized chips are made by describing their functionality using a hardware-description language (HDL), such as Verilog or VHDL. The hardware description is often written to characterize the design in terms of a set of functional macros. The design is computer simulated to ensure that the custom design criteria are satisfied. For highly-complex custom chip designs, the above process can be burdensome and costly. The highly integrated structure of such chips leads to unexpected problems, such as signal timing, noise-coupling, and signal-level issues. Consequently, such complex custom chip designs involve extensive validation. This validation is generally performed at different stages using a Verilog or VHDL simulator. Once validated at this level, the Verilog or VHDL HDL code is synthesized, for example, using “Synopsys,” to a netlist that is supplied to an ASIC (Application Specific Integrated Circuit) foundry for prototype fabrication. The ASIC prototype is then tested in silicon. Even after such validation with the Verilog or VHDL simulator, unexpected problems are typical. Overcoming these problems involves more iterations of the above process, with testing and validation at both the simulation and prototype stages. Such repetition significantly increases the design time and cost to such a degree that this practice is often intolerable in today's time-sensitive market.

Similar problems manifest in semi-custom designs such as programmable logic devices. Also known as “PLDs”, programmable logic devices are a well-known type of integrated circuit that can be programmed to perform specified logic functions. One of the more commons types of PLD is the field programmable gate array (FPGA) which has a number of different circuit tiles, each of which permits certain flexibility for programming its functionality. Although programming most PLDs would be significantly faster than most complex custom chip designs, such efforts still involve significant delays.

As illustrated and described in U.S. Pat. No. 6,347,395 issued Feb. 12, 2002, and entitled, “Method and Arrangement for Rapid Silicon Prototyping”, a typical development period (from initial design to new product) can be reduced by more that fifty percent by way of a rapid silicon prototyping process and arrangement. However, even with rapid silicon prototyping, substantial delay can be required to compile a design that is modified to evaluate new algorithms or to address problems discovered during validation.

These chip-development problems are accentuated when attempting to process streaming data in real time or in near real time where the degree of delay is tolerable on an application-by-application basis.

Accordingly, there is a need for a way to develop customized (including semi-customized) chips that overcomes the above-mentioned deficiencies. The present invention addresses this need, and other needs, by way of design modeling per the examples disclosed herein.

Various aspects of the present invention are directed to design modeling and/or processing of streaming data in a manner that addresses and overcomes the above-mentioned issues. Consistent with one example embodiment, a system to model a hardware specification includes a platform arranged to receive an input data stream and transmit an output data stream. The system also includes a source for a streaming application adapted to provide the input data stream at a source data rate, a destination for the streaming application adapted to consume the output data stream at a destination data rate, and a data channel coupling the platform and a general purpose computer. The general purpose computer is adapted to generate, according to at least a portion of the hardware specification, from a first intermediate data stream, which is received from the platform via the data channel, a second intermediate data stream, which is sent to the platform via the data channel, wherein the first intermediate data stream is based on the input data stream and the output data stream is based on the second intermediate data stream.

Another embodiment of the present invention discloses a method for modeling an electronic design. The method includes separating the electronic design for a streaming application into a start portion receiving an input data stream for the streaming application, an intermediate portion, and an end portion transmitting an output data stream for the streaming application, based on the streaming data flow through the electronic design. The method also includes producing a hardware specification for the start portion and the end portion, producing an abstract software model for the intermediate portion, and generating configuration data for a programmable logic device (PLD) implementation from the hardware specification, wherein the PLD includes configurable logic and configurable routing that are programmed by the configuration data. The method further includes generating an executable program from the abstract software model and operating the PLD using the configuration data and a general purpose computer using the executable program, wherein the electronic design is modeled by the operation of the PLD and the general purpose computer.

The invention may be more completely understood in consideration of the following detailed description of various embodiments of the invention in connection with the accompanying drawings, in which:

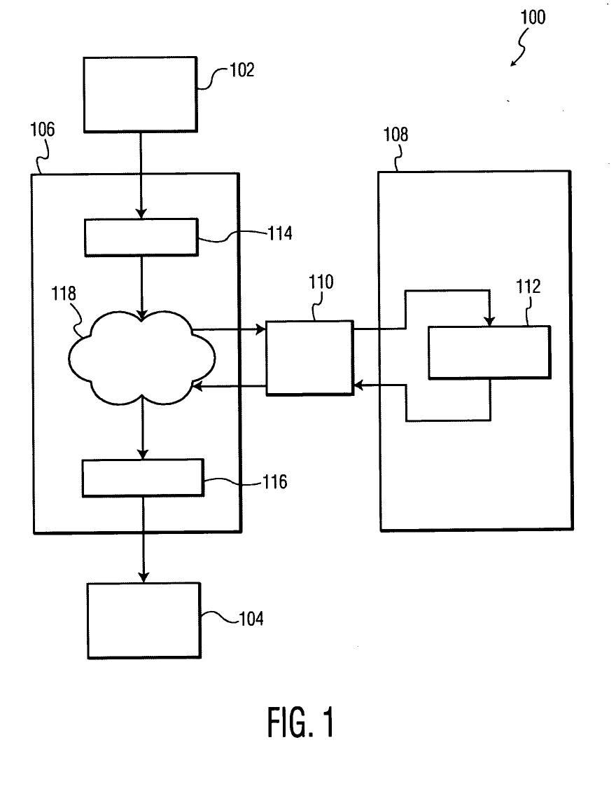

FIG. 1 is a block diagram of an example system for real-time abstract modeling of a streaming application, according to the present invention;

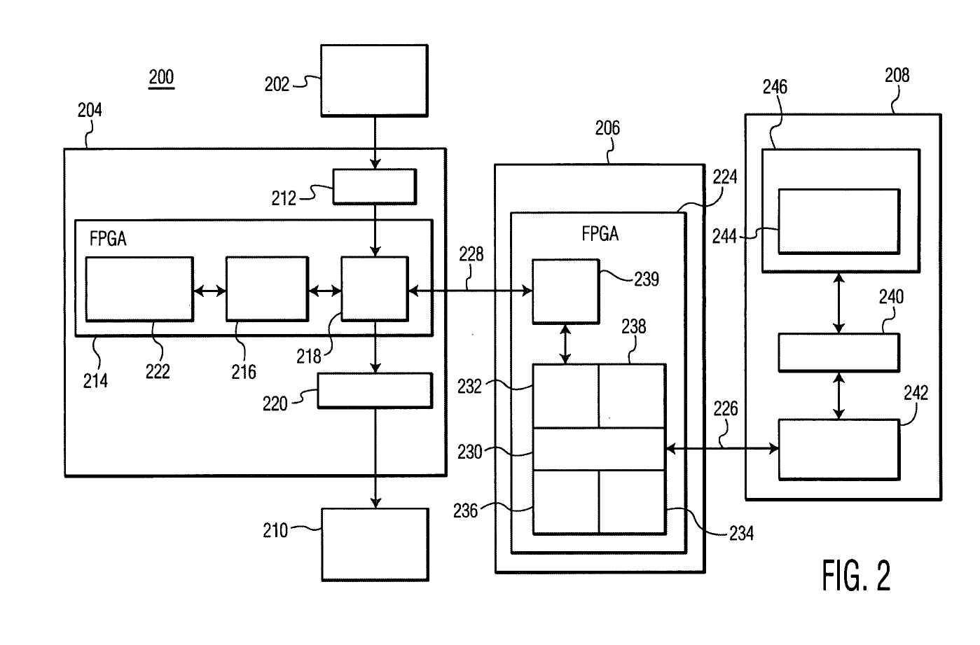

FIG. 2 is a block diagram of another example system for real-time abstract modeling of a streaming application, according to the present invention; and

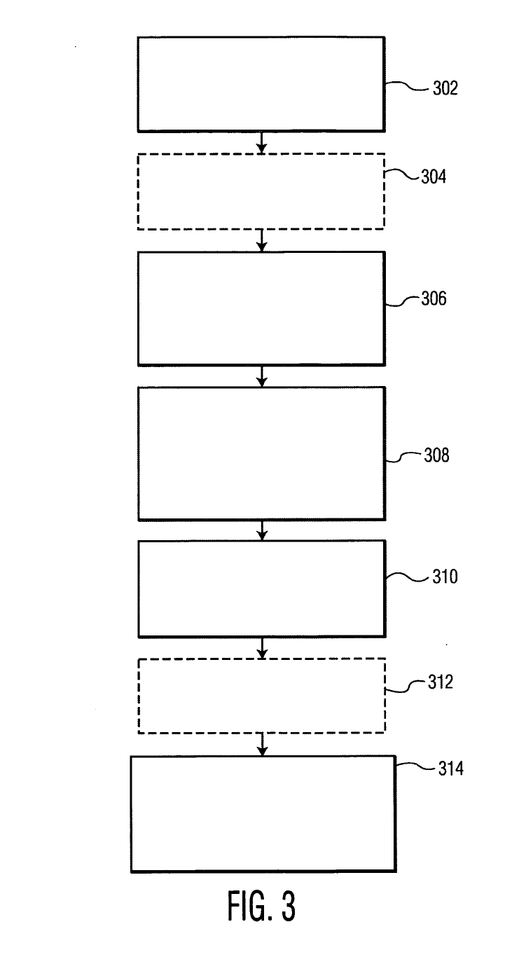

FIG. 3 is a flow diagram of an example process for real-time abstract modeling of a streaming application, according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

The present invention is believed to be generally applicable to methods and arrangements for processing data using circuits that require or benefit from fast compilations of circuit-configuration data. The invention has been found to be particularly advantageous for processing of streaming data in real time or in near real time where the degree of delay is tolerable on an application-by-application basis. While the present invention is not necessarily limited to such applications, an appreciation of various aspects of the invention is best gained through a discussion of examples in such an environment.

According to one example embodiment of the present invention, a system to model a hardware specification includes a platform arranged to receive an input data stream and transmit an output data stream. The system also includes a source for a streaming application adapted to provide the input data stream at a source data rate, a destination for the streaming application adapted to consume the output data stream at a destination data rate, and a data channel coupling the platform and a general purpose computer. The general purpose computer is adapted to generate, according to at least a portion of the hardware specification, from a first intermediate data stream, which is received from the platform via the data channel, a second intermediate data stream, which is sent to the platform via the data channel, wherein the first intermediate data stream is based on the input data stream and the output data stream is based on the second intermediate data stream.

Referring to FIG. 1, a block diagram is shown of a system 100 for real-time abstract modeling of a streaming application, according to the present invention. The streaming application has a source 102 of streaming data, for example, a streaming video or audio source, such as a video tape player, video disk player, or music audio player. The streaming application has a destination 104 for streaming data, such as a video display device or audio speakers. The data from the source 102 is processed by the combination of the platform 106 and the general purpose computer 108, according to the hardware specification of the streaming application, before delivery of the processed data to the destination 104. The platform 106 and the computer 108 communicate via channel 110.

The platform 106 can be a PLD based platform or other device that is programmed to perform a portion of the streaming application. Alternatively, the platform 106 may be a SOC based platform that includes a system-on-a-chip (SOC). Example platforms 106 for Philips Semiconductors include Rapid Silicon Prototyping and the Nexperia platform together with the Nexperia Advanced Prototyping Architecture.

An example SOC for a platform 106 may include a wide variety of building blocks, such one or more digital signal processing blocks, which are typically used in the design of streaming applications. Certain portions of the hardware specification of the streaming application may include instances for a subset of the available building blocks, and the remaining portions of the hardware specification may be modeled by computer 108. For example, a streaming application may include various standard blocks and an innovative custom block The streaming application may be modeled by system 100 with the standard blocks modeled by the platform 106 and the custom block modeled by a software processing function 112 on computer 108. Various alternative designs for the custom block may be quickly evaluated by system 100, because the custom block modeled by software processing function 112 may be rapidly modified and recompiled.

The platform 106 typically includes a receiver 114 to receive streaming data from the application data source 102. The receiver 114 may include processing functions, such as the conversion of analog signals from a video tape player 102 into a digital video stream. The platform 106 typically includes a transmitter 116 to provide processed streaming data to the application data destination 104. The transmitter 116 may include processing functions, such as the conversion of a processed digital video stream into analog signals for a video display unit 104. It will be appreciated that the receiver 114 and transmitter 116 may either be included within or be separate from the PLD or SOC on which platform 106 is based.

Hardware processing function 118 may perform a portion of the processing for the streaming application. Hardware processing function 118 implements an interface to channel 110. Examples for channel 110 include a parallel bus, such as PCI X, and a serial or parallel communications link, such as PCI Express. Typically, channel 110 provides high bandwidth in accordance with the particular streaming application. Channel 110 may be a communication protocol directly supported by computer 108 or an adapter between a communication protocol supported by computer 108 and another communication protocol, such as a proprietary communication protocol.

Hardware processing 118 typically sends a partially processed version of the streaming data received from application data source 102 to computer 108 via channel 110. It will be appreciated that hardware processing 118 may send only a portion of the streaming data, such as the data for one color component of color video data, to the computer 108. It will be appreciated that hardware processing 118 may send streaming data to computer 108 without prior processing. Hardware processing 118 also receives streaming data from computer 108 via channel 110 that has been processed by processing function 112. Hardware processing 118 sends streaming data to application data destination 104 that is based on the streaming data received from computer 108. Hardware processing 118 may perform additional processing of the streaming data before providing the streaming data to application data destination 104.

Software processing function 112 may be a compiled software function on the general purpose computer 108. The streaming data received from platform 106 by function 112 and the streaming data sent to platform 106 by function 112 may be abstract data types, such as a sequence of numbers each representing an intensity value for a pixel of streaming video data. The available abstract data manipulation functions provided by computer 108, such as multiplication and addition, may be used to abstractly process the streaming data that is abstractly represented. An example function 112 scales the orientation of a video image vertically and/or horizontally.

It should be understood that the elements described in the figures are for description only, to aid in the understanding of the present invention. As is known in the art, elements described as hardware may equivalently be implemented in software. Reference to specific electronic circuitry is also only to aid in the understanding of the present invention, and any circuit to perform essentially the same function is to be considered an equivalent circuit.

Referring to FIG. 2, a block diagram is shown for another example system 200 for real-time abstract modeling of a streaming application, according to the present invention. Data for the streaming application from source 202 is processed by the combination of PLD based platform 204, channel 206, and computer 208, and the processed data for the streaming application is delivered to destination 210.

The platform 204 may include a receiver 212 that receives the streaming data from the application data source 202 and provides the streaming data to an FPGA 214. FPGA 214 may include a memory 216 and FPGA 214 may be programmed to implement a DMA block 218 that interfaces with memory 216. DMA block 218 may provide four independent DMA channels to memory 216. A first DMA channel may be used to write data received from source 202 via receiver 212 into memory 216, a second DMA channel may be used to read data from memory 216 for delivery to application data destination 210 via transmitter 220, a third DMA channel may be used to read streaming data from memory 216 for delivery to computer 208 via channel 206, and a fourth DMA channel may be used to write streaming data received from computer 208 via channel 206 to memory 216.

Memory 216 may be a dual port memory with the DMA block 218 connected to one port and the FPGA 214 programmed to implement a processing block 222 that is connected to the other port. The processing block 222 may perform processing of the streaming data received from source 202 before the processed data is delivered to computer 208 and the processing block 222 may perform processing of the streaming data received from computer 208 before the processed data is delivered to destination 210. Thus, the streaming data from source 202 may undergo three sequential processing operations, by the processing block 222, the computer 208, and again the processing block 222, before delivery to the destination 210. It will be appreciated that either or both of these processing operations by processing block 222 may be omitted, according to the specification of the streaming application. In one embodiment, processing block 222 may include a processor.

In one embodiment, channel 206 is a PCI-X card that is plugged into a server computer 208. The PCI-X card 206 includes another FPGA 224 that is programmed to implement an adapter function between the PCI-X protocol of the PCI-X bus on line 226 and a proprietary communication protocol on line 228 that is based on low level differential signaling supported by FPGA 214 and FPGA 224. The adapter function of FPGA 224 includes a PCI-X core 230, a memory-mapped DMA controller 232, a memory-mapped bridge 234 for I/O transactions, a memory mapped bridge 236 for memory transactions, an interrupt controller 238 and a channel controller 239. The PCI-X core 230 may implement the PCI-X protocol for the PCI-X bus on line 226. The memory-mapped DMA controller 232 may be controlled by the computer 208 to read burst data transfers from memory 216 to deliver streaming data to memory 240 of computer 208 via PCI-X controller 242. The computer 208 may generate burst data transfers causing PCI-X controller 242 to send streaming data to memory 216 via memory-mapped bridge 236.

The streaming data from the platform 204 may be stored in a buffer in memory 240. In one embodiment, the streaming data is broken into data blocks and multiple buffers are provided for the data blocks, such that one buffer may be receiving a block streaming data from platform 204, while another buffer is simultaneously being processed by processing function 244 executing on processor 246 of computer 208, and a block of streaming data is simultaneously being sent to platform 204 from yet another buffer. With a greater number of buffers, the various data transfer and data processing function may be further decoupled.

In one embodiment, on completing the evaluation of various design options for a processing function 244, the abstract implementation of the processing function 244 may be translated into a hardware specification that is implemented in FPGA 214, such that channel 206 and computer 208 are no longer needed to perform the streaming application.

Referring to FIG. 3, a flow diagram is shown as an example of one process for real-time abstract modeling of a streaming application, according to the present invention. The streaming application delivers to a destination processed streaming data from a source.

At step 302, a hardware platform receives streaming data from an application data source, such as a source of a video and/or audio stream. At step 304, the hardware platform optionally performs a processing of the streaming data from the data source. At step 306, streaming data is transferred from the hardware platform to a general purpose computer. If the hardware platform performed processing at step 304, then the streaming data transferred at step 306 is the streaming data after the processing of step 304, otherwise the streaming data transferred at step 306 is the data received from the source at step 302.

At step 308, software on the general purpose computer creates a processed data stream from the data stream transferred at step 306. Various design options for the processing of step 308 may be quickly evaluated at an abstract level by modifying and recompiling the software, allowing a particular design option to be selected according to the evaluation criteria.

At step 310, the processed data stream from step 308 is transferred from the general purpose computer to the hardware platform. At step 312, the processed data stream from step 308 is optionally further processed by the hardware platform, with the result sent from the hardware platform to an application data destination.

Accordingly, various embodiments have been described by way of the figures and/or discussion as example implementations of the present invention involving abstract modeling of streaming data applications. The present invention should not be considered limited to these particular example implementations. Various modifications, equivalent processes, as well as numerous structures to which the present invention may be applicable fall within the scope of the present invention. Such variations may be considered as part of the claimed invention, as fairly set forth in the appended claims.

What is claimed is:

1. A system to model a hardware specification, comprising: a platform (106) arranged to receive an input data stream and transmit an output data stream; a source (102) for a streaming application adapted to provide the input data stream at a source data rate; a destination (104) for the streaming application adapted to consume the output data stream at a destination data rate; a data channel (110) coupling the platform and a general purpose computer (108); and the general purpose computer adapted to generate according to at least a portion of the hardware specification, from a first intermediate data stream, which is received from the platform via the data channel, a second intermediate data stream, which is sent to the platform via the data channel, wherein the first intermediate data stream is based on the input data stream, the output data stream is based on the second intermediate data stream.

2. The system of claim 1, wherein the platform is based on a programmable logic device (PLD).

3. The system of claim 2, wherein the PLD-based platform includes at least one memory arranged to store a moving interval of the input data stream, the first intermediate data stream, the second intermediate data stream, and the output data stream.

4. The system of claim 2, wherein the PLD-based platform is adapted to generate according to at least a portion of the hardware specification, the first intermediate data stream from the input data stream.

5. The system of claim 2, wherein the PLD-based platform is adapted to generate according to at least a portion of the hardware specification, the output data stream from the second intermediate data stream.

6. The system of claim 2, wherein the PLD-based platform includes a PLD that includes configurable logic and configurable routing.

7. The system of claim 1, wherein the first intermediate data stream is a copy of the input stream, the output data stream is a copy of the second intermediate data stream, and the general purpose computer is adapted to generate the second intermediate data stream from the first intermediate data stream according to the hardware specification.

8. A method for modeling an electronic design, comprising: separating the electronic design for a streaming application into a start portion receiving an input data stream for the streaming application, an intermediate portion (112), and an end portion transmitting an output data stream for the streaming application, based on the streaming data flow through the electronic design; producing a hardware specification for the start portion and the end portion; producing an abstract software model for the intermediate portion; generating configuration data for a programmable logic device (PLD) implementation from the hardware specification, wherein the PLD (118) includes configurable logic and configurable routing that are programmed by the configuration data;
generating an executable program from the abstract software model; and operating the PLD using the configuration data and a general purpose computer (108) using the executable program, wherein the operating models the electronic design.

9. The method of claim 8, further comprising validating the electronic design based on the operating.

10. The method of claim 8, further comprising: generating a derived hardware specification from the abstract software model; generating another configuration data for a PLD implementation from the hardware specification and the derived hardware specification; and operating the PLD using the another configuration data, wherein the operating implements the electronic design.
